(19) United States
(12) Patent Application Publication
(10) Pub. No.: US 2026/0210626 A1
(43) Pub. Date: Jul. 23, 2026

(54) System, Drying Device and Method for Double-Sided Drying of a Coated Film, in Particular a Battery Electrode Film

(71) Applicant: AXBIS CO.,LTD., Daejeon (KR)

(72) Inventors: Oliver Bocksrocker, Sachsenheim (DE); Wilrid Dubitzky, Leonberg (DE); Holger Joachim Mönch, Vaals (NL); Günter Ambrosy, Stuttgart (DE); Rolf Apetz, Aachen (DE); Dennis Groben, Aachen (DE)

(21) Appl. No.: 19/453,460

(22) Filed: Jan. 20, 2026

(30) Foreign Application Priority Data
Jan. 20, 2025 (DE) 102025101819.7

(51) Int. Cl. F26B 3/28; F26B 13/14; H01M 4/04

(52) U.S. Cl. CPC F26B 3/283; F26B 13/14; H01M 4/04

(57) ABSTRACT

The present disclosure relates to a system for drying a coated film on both sides, the system including a first radiation source module configured to emit first radiation toward a first side of the coated film, a second radiation source module configured to emit second radiation toward a second side of the coated film, and a transport means configured to guide the coated film along a transport direction between the first and second radiation source modules. The present disclosure further relates to a corresponding drying apparatus and a corresponding method for drying a coated film on both sides.

### CROSS-REFERENCE TO RELATED APPLICATION(S

The present application claims the benefit of priority to German Patent Application No. 102025101819.7, filed on January 20, 2025, in the German Patent and Trade Mark Office, the entire disclosure of which is incorporated herein by reference.

### TECHNICAL FIELD

The present disclosure relates to a system, an apparatus, and a method for drying a coated film.

### BACKGROUND

Batteries, such as lithium-ion batteries, are essential for use in applications such as electric vehicles and mobile devices. A key component of such batteries is an electrode film, which consists of a metal carrier such as aluminum or copper, on which a layer including an active material, a binder, and a solvent is coated. After coating, the film is dried to evaporate the solvent and form a uniform and stable layer.

The drying process is typically performed as a roll-to-roll process in which the continuously coated film is passed through a drying zone. In such case, hot air blowers or infrared radiators may be used, which enable uniform single-sided heating of the absorbing surface of the coating in a horizontally aligned configuration. However, the coating may be damaged by overheating or may form wrinkles due to non-uniform drying.

### SUMMARY

The present disclosure is directed to providing an improved system, apparatus, and method for a drying process of a coated film.

According to one aspect of the present disclosure, a system for drying a coated film on both sides is provided, the system including a first radiation source module configured to emit first radiation toward a first side of the coated film, a second radiation source module configured to emit second radiation toward a second side of the coated film, and a transport means configured to guide the coated film along a transport direction between the first and second radiation source modules. The first radiation source module and the second radiation source module may be arranged opposite to each other or offset from each other. The first and second radiation source modules may be configured to emit the first and second radiation in opposite directions toward the coated film positioned therebetween. The transport means may be arranged on the first side and/or the second side of the coated film. The transport means may be configured to guide the coated film along a predetermined transport direction relative to and between at least two radiation source modules.

According to another aspect of the present disclosure, a corresponding drying apparatus for the system is provided, the drying apparatus including a first radiation source module configured to emit first radiation toward a first side of the coated film, and a second radiation source module configured to emit second radiation toward a second side of the coated film.

According to yet another aspect of the present disclosure, a method for drying a coated film on both sides is provided, the method including emitting first radiation toward a first side of the coated film and emitting second radiation toward a second side of the coated film. The method may include guiding the coated film along a transport direction between a first radiation source module configured to emit first radiation toward the first side of the coated film and a second radiation source module configured to emit second radiation toward the second side of the coated film.

Certain preferred embodiments of the present disclosure are defined in the dependent claims. It is understood that the claimed method and drying apparatus may have similar and/or identical preferred embodiments to the claimed system, particularly as defined in the dependent claims and disclosed herein.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a schematic side view of a system for drying a coated film on both sides;

FIG. 2 is a schematic plan view of an exemplary drying line;

FIG. 3 is a schematic plan view of a part of the system of FIG. 1;

FIG. 4 is a schematic diagram of a second embodiment of a system for drying a coated film on both sides;

FIG. 5 is a schematic diagram of a third embodiment of a system for drying a coated film on both sides;

FIG. 6 is a schematic diagram of a fourth embodiment of a system for drying a coated film on both sides;

FIG. 7 is a schematic diagram of a fifth embodiment of a system for drying a coated film on both sides;

FIG. 8 is a schematic diagram of a sixth embodiment of a system for drying a coated film on both sides; and

FIG. 9 is a flowchart of a method for drying a coated film on both sides.

### DETAILED DESCRIPTION

Hereinafter, some embodiments of the present disclosure will be described in more detail. However, the following embodiments are provided merely as references for describing the present disclosure in detail, and the present disclosure is not limited thereto and may be implemented in various forms.

Unless otherwise defined, all technical and scientific terms used in the present disclosure have the same meanings as commonly understood by those skilled in the art of this application. The terms "include," "comprise," and any variations thereof used in the specification of this application are intended to encompass non-exclusive inclusion.

In the description of the present disclosure, it shall be noted that, unless explicitly defined or limited otherwise, terms such as "mounted," "interconnected," "connected," etc., should be interpreted broadly. For example, they may be fixed connections, detachable connections, or integral connections, and they may be directly interconnected, or indirectly interconnected through intermediate media. Those of ordinary skill in the art should understand the specific meanings of the above-mentioned terms in the present application according to the specific situation.

The present disclosure may use ordinal numbers such as "first," "second," "third," etc., to refer to elements, and it should be noted that, unless explicitly indicated otherwise, these are merely used to distinguish between different elements and do not imply that the mentioned elements are necessarily provided in the indicated order in terms of time, space, or other aspects.

The present disclosure is based on the concept of irradiating a single-sided or double-sided coated battery electrode film from both sides to protect the battery electrode film from overheating damage and to prevent wrinkle formation through uniform drying.

The inventors of the present disclosure recognized that various issues may arise during single-sided drying of a coated electrode film, particularly due to single-sided heat input. As a result, large temperature gradients may lead to coating damage and inefficient drying processes. Since heat must penetrate through the entire coating from one side, higher temperatures may be required at the irradiated surface, which increases the risk of overheating. In single-sided drying, the temperature gradient is particularly steep because there is no heat input from the opposite side and heat is rapidly dissipated through the carrier film. Single-sided drying may result in non-uniform drying along a layer thickness regardless of whether the coating is single-sided or double-sided.

Furthermore, temperature differences may cause structural damage such as cracks, peeling (flaking), or delamination. For a double-sided coating, single-sided sequential irradiation may significantly extend the required drying line, reducing process speed. Moreover, thermal stress may cause deformation such as wrinkle formation, degrading the quality of a battery electrode film.

According to one aspect of the present disclosure, to address one or more of the above issues, it is proposed that the film be irradiated from both sides as a targeted approach, even if the coated film (for example, a battery electrode film) is single-sided coated. The drying process may be further optimized by coordinated selection of a wavelength of the radiation. Specific adjustment of the radiation may lead to increased absorption and reduced reflection, enhancing process efficiency. This may reduce film damage and ensure uniform heat distribution, preventing deformation, cracks, or delamination.

In particular, the system may be configured to guide the coated film along a vertical transport direction between the first radiation source module and the second radiation source module. By guiding the coated film along a vertical transport direction in conjunction with irradiation from both sides, an evaporation medium may be efficiently released from both sides. Arranging radiation source modules—here, particularly VCSEL modules—in a folded structure within the drying line may significantly shorten the drying line compared to a conventional convection oven. Furthermore, alternately arranging VCSEL modules and transport means may ensure uniform heat concentration, and thereby may prevent overheating.

Uniform spatial and temporal output distribution may support direct or indirect monitoring of a drying progress by sensors such as thermal imaging cameras or photodetectors. This may reliably prevent moisture pockets and overheating, thereby improving an overall process yield and enhancing the quality of the coated film.

According to the present disclosure, a system for drying a coated film on both sides has at least two radiation source modules and/or lasers or laser modules. The coated film may be a battery electrode film. The film may include, for example, copper or aluminum as a substrate and/or a carrier film, with a thickness typically of 5–30 μm, particularly 6–15 μm, and may include nickel, manganese, cobalt, lithium iron phosphate, or graphite as a coating, with a thickness typically of 20–200 μm, particularly 50–150 μm.

At least one of the radiation source modules may be a laser diode module, for example a VCSEL module having a plurality of vertical-cavity surface-emitting lasers (VCSELs). In particular, the first radiation source module and the second radiation source module on opposite sides may be laser diode modules, particularly VCSEL modules. A module length may be in a range of 300–1800 mm, particularly 500–1700 mm, and a width may be in a range of 50–500 mm, particularly 80–400 mm. At least two VCSEL modules may be arranged in series with each other. The number of VCSEL chips may be in the range of 100–50,000, particularly 1,000–10,000. The laser output per VCSEL chip may be in the range of 1–20 W, typically 2 W. The laser output per module may be in the range of 2–50 kW, typically 4–40 kW. A preferred design may divide the module into a plurality of regions and/or zones that may be individually driven to control a local radiation intensity under the module. The number of zones per module may be in the range of 4–400, particularly 10–100.

The radiation source modules are configured to emit radiation toward the coated film from different sides. The modules may include one or more direct diode lasers or fiber lasers, but may particularly include VCSELs. The optical radiation of at least one module may be in a wavelength range of 750–1300 nm, particularly 800–1250 nm, particularly 900–1170 nm.

The first radiation source module and the second radiation source module may be arranged opposite each other. The first radiation source module and the second radiation source module may be configured to simultaneously irradiate the same area of the coated film from both sides. The modules may be arranged such that the first radiation source module emits radiation from a first side of the coated film and the second radiation source module emits radiation

toward the same position of the coated film from an opposite second side of the coated film. The two radiation source modules may be arranged, for example, on a same axis perpendicular to the transport direction, but may be arranged on different sides of the coated film, particularly a battery electrode film. As a result, temperature gradients may be reduced, and deformation, cracks, and delamination may occur less frequently.

However, the first radiation source module and the second radiation source module may also be arranged offset from each other. The first radiation source module and the second radiation source module may be configured to simultaneously irradiate different areas of the coated film from both sides. The modules may emit radiation at different positions with respect to the transport direction. Unlike the previous embodiment, the radiation source modules are not arranged opposite each other and are not positioned on the same axis. Optionally, the different areas may have partial overlap of irradiation zones. An overlap rate of the different areas may be at least 10%, particularly at least 20%, particularly at least 30%. Alternatively or additionally, the overlap rate of the different areas may be 70% or less, particularly 60% or less, particularly 50% or less, particularly 40% or less. This again may have the advantage of reducing heat concentration at specific points of a battery electrode film, thereby preventing or at least reducing overheating.

At least one transport means may be arranged opposite the first radiation source module and/or the second radiation source module. Instead of the opposing radiation source modules in the above embodiment, at least one transport means may be arranged on the same axis as the opposing radiation source modules, but on the opposite side of the coated film. Due to the thermal mass and/or thermal effect of the transport means that is arranged opposite the radiation source module, the risk of heat concentration or overheating may be prevented or at least reduced.

The system may further include an additional second radiation source module in addition to the second radiation source module. The additional second radiation source module may be configured to emit additional second radiation toward the second side of the coated film. That is, a plurality of second radiation source modules configured to emit second radiation toward the second side of the coated film may be provided. In this case, the transport means may be arranged between the second radiation source module and the additional second radiation source module. In particular, the transport means may be arranged between the radiation source modules and configured to act as a barrier against radiation emitted from the second radiation source module toward the coated film and radiation that is back-reflected from the coated film toward the additional second radiation source module. In this case, the back-reflected radiation may include not only specularly reflected radiation but also scattered radiation. This may allow better control of an amount of radiation incident on different areas of the coated film, and may also provide better guidance of the coated film at a clearly defined distance (gap) relative to the second radiation source module and/or the additional second radiation source module.

The system may have a plurality of transport means, a plurality of first radiation source modules, and a plurality of second radiation source modules. In one embodiment, the plurality of transport means and the plurality of first radiation source modules or the plurality of second radiation source modules may be arranged alternately, such that, on the first side of the coated film or the second side of the coated film, at least one radiation source module is arranged between two transport means.

A plurality of radiation source modules may be arranged alternately and configured to irradiate the coated film alternately from the first side and the second side. In particular, a plurality of first radiation source modules and a plurality of second radiation source modules may be arranged alternately and configured to irradiate the coated film alternately from the first side and the second side. This may provide the advantages of heating from both sides while reducing the risk of overheating. Optionally, transport means may be arranged between each radiation source module or group of radiation source modules, respectively. The transport means may be guide elements. The configuration and advantages described above for the transport means arranged between the second radiation source module and the additional second radiation source module apply equally to the transport means arranged between each radiation source module or group of radiation source modules.

One or more first radiation source modules and one or more second radiation source modules may be arranged symmetrically. For example, a mirror-symmetric arrangement of one or more first radiation source modules and one or more second radiation source modules on both sides of the coated film may be provided. This may enable particularly uniform drying. In addition, for example, in the case of an alternating arrangement of first and second radiation source modules, a rotationally symmetric or point symmetric arrangement of one or more first radiation source modules and one or more second radiation source modules is also possible. This may enable uniform drying and/or prevent overheating through uniformly distributed heat input.

The first and second radiation source modules may be provided in the same number. However, different numbers of first and second radiation source modules may be provided on opposite sides of the coated film. Alternatively or additionally, the same or different types of first and second radiation source modules may be provided on opposite sides of the coated film. The distance of one or more radiation source modules with respect to the coated film may be the same or different. For example, the distance of one or more first radiation source modules with respect to the coated film may be different from the distance of one or more second radiation source modules with respect to the coated film. Furthermore, a plurality of first radiation source modules may be provided at different distances from each other. Particularly for single-sided coated or differently coated films, different modules and/or different numbers and/or spacings may be provided on opposite sides of the coated film.

In a preferred configuration, the transport direction may be aligned vertically. The transport means may be configured to pass the coated film between the first radiation source module and the second radiation source module in a vertical direction. The first radiation source module may be configured to irradiate the coated film from the first side in a horizontal direction. The second radiation source module may be configured to irradiate the coated film from the second side in an opposite horizontal direction. In this case, the transport direction between the radiation source modules is substantially vertical, i.e., vertical from bottom to top or from top to bottom, and may have an inclination angle. This may provide the advantage that the evaporation medium may be released more easily from both sides of the battery electrode film. In the present disclosure, an angle of 90° ± 30°, particularly 90° ± 20°, particularly 90° ± 10° relative to the horizontal plane is still understood as a vertical direction. Accordingly, the horizontal direction includes an angle of ±30°, particularly ±20°, particularly ±10° relative to the horizontal plane.

The system may be configured to guide the coated film along a folded path past a plurality of radiation source modules by a plurality of transport means. The system may be configured to guide the coated film past a plurality of radiation source modules along an S-shaped or curved path defined by guide elements arranged on both sides. The system may be configured to pass the coated film, particularly by a plurality of transport means, upward in a vertical direction between a first radiation source module and a second radiation source module in a first vertical section. Furthermore, the system may be configured to pass the coated film downward in a vertical direction between an additional first radiation source module and an additional second radiation source module in a second vertical section.

The system may be designed in a folded arrangement. This means that the transport direction of the coated film follows, for example, a folded, curved, or S-shaped path. In this case, the transport means may be arranged to guide the coated film at least sectionally through a sequence of radiation source modules arranged on both sides along different transport directions. During transport, the film is deflected at points determined by the transport means, so that the alignment of the transport direction changes alternately. This folded arrangement may provide the advantage of being able to significantly reduce the drying line and thus the oven length.

According to the present disclosure, the system may have at least one transport means. The transport means may include rollers or air cushions. The transport means may be arranged on the first side and/or the second side of the coated film. The transport means may be configured to maintain a path of the film and to guide the film through the system at least sectionally between radiation source modules along a transport or conveying direction.

According to one aspect of the present disclosure, at least one first radiation source module configured to emit first radiation toward the first side of the coated film and a second radiation source module configured to emit second radiation toward the second side of the coated film are provided. The radiation emitted by the two modules may be in the same or different wavelength ranges. The first radiation source module may be configured to emit radiation having a first radiation spectrum. The second radiation source module may be configured to emit radiation having a second radiation spectrum different from the first radiation spectrum. For example, the system may be configured to irradiate the film such that one of the first side and the second side of the film is irradiated with radiation in the near-infrared range and the other side is irradiated with radiation in a different spectral range.

The coated film may have coating only on the first side. This may mean that the coating to be dried exists only on one side of the film. The system may be configured, for single-sided coated films, to irradiate the coated side of the film with radiation in the infrared range, particularly the near-infrared range, particularly the 780–1100 nm range, and to irradiate the non-coated side of the film with radiation in a different spectral range, particularly the visible light range, particularly the 440–550 nm range. For some films, this may enable increased absorption, reduced reflection, increased efficiency, and/or reduced working distance.

The system may include a convection dryer using hot air arranged downstream of the radiation source modules in the transport direction. The system including the first and second radiation source modules may be arranged immediately downstream of a coating process of the coated film, for example, in a first drying zone of an overall drying line. This may provide the advantage of enabling an efficient and fast drying process. Optionally, VCSEL modules may also be arranged in subsequent sections or multiple partial sections of the drying line. This may enable efficient drying, rapid achievement of target dryness, and shortening of the drying line.

The moisture content before entering the drying oven is generally hundreds to thousands of ppm (parts per million). The goal of the drying process may be to reduce this value to at least one-tenth, so that the residual moisture after drying is markedly lowered. In particular, the system may be configured to reduce the moisture content of coated battery electrode films from hundreds to thousands of ppm to at least one-tenth. Drying on both sides using one or more radiation source modules may shorten the drying line compared to convection ovens.

The features described above and the features to be further described below may be used not only in the specified combinations but also in other combinations or individually, without departing from the scope of the present disclosure.

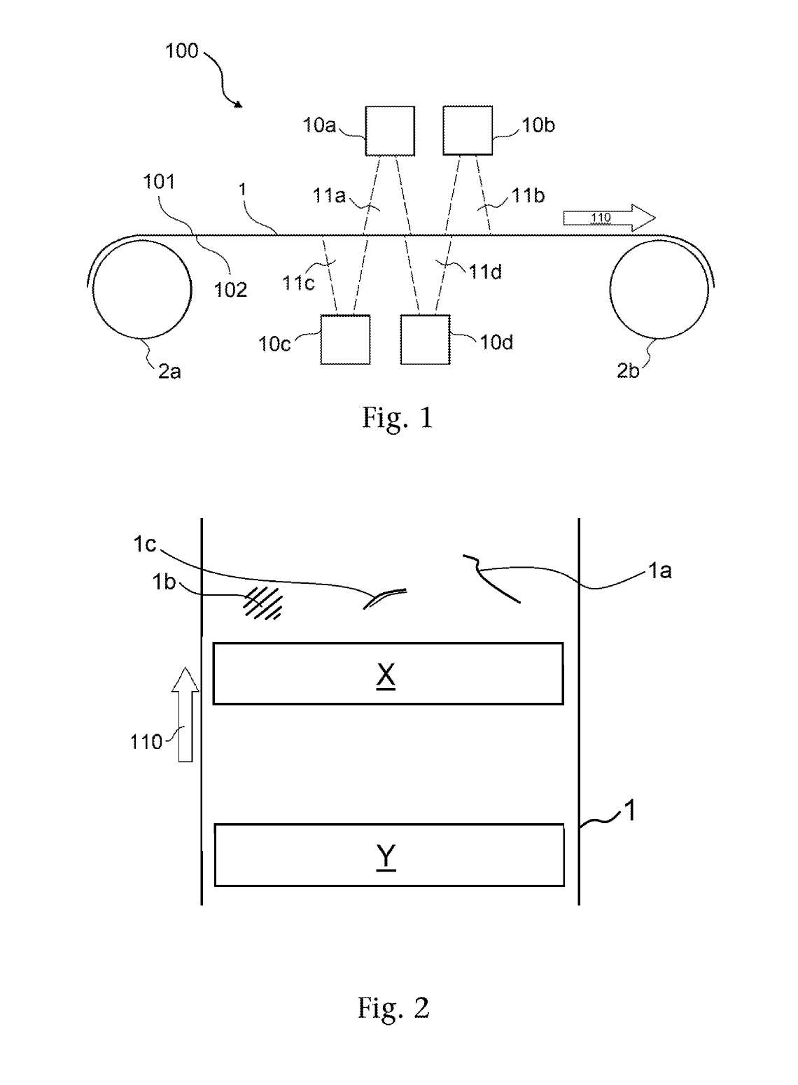

FIG. 1 is a schematic side view of a system 100 for drying a coated film on both sides, particularly a battery electrode film 1. The system includes a drying apparatus comprising at least one first radiation source module 10a, 10b configured to emit first radiation 11a, 11b toward a first side 101 of the coated film 1, and at least one second radiation source module 10c, 10d configured to emit second radiation 11c, 11d toward a second side 102 of the coated film 1. In the example shown in FIG. 1, two first radiation source modules 10a, 10b and two second radiation source modules 10c, 10d are provided. The system also includes at least one transport means 2a, 2b for guiding the coated film 1 along a transport direction 110 between the radiation source modules 10a to 10d. In the example shown in FIG. 1, two transport means 2a, 2b are provided.

The system may have different numbers of radiation source modules on opposite sides of the coated film. The radiation source modules may be arranged at the same distance from the coated film or at different distances from the coated film, at least in part. The radiation source modules may be at least partially the same as or different from each other, for example, in terms of spectrum and/or output. Particularly when the coated film has different coatings or has coating only on one side, the irradiation or drying output may be adjusted in a targeted manner based on the coating on each side of the coated film.

The battery electrode film 1 may be an anode film or a cathode film. As substrate materials, for example, copper, aluminum, iron, or lithium may be used. As coating materials, particularly nickel, manganese, cobalt, lithium iron phosphate, and/or graphite may be used.

The transport means 2a, 2b may be, for example, rollers or air cushions. The transport means may actively contribute to the transport of the battery electrode film 1, or may also be formed as passive guide elements. However, in any case, the transport means may ensure that the film maintains its path in at least one spatial direction. The transport means 2a, 2b may pass the coated film 1 between the first radiation source modules 10a, 10b on the first side and the second radiation source modules 10c, 10d on the second side, and form part of the system 100.

The radiation source modules may be laser diode modules, particularly VCSEL modules 10a to 10d. The VCSEL modules 10a to 10d are configured to emit, toward the battery electrode film 1, radiation 11a to 11d that contributes to drying of the battery electrode film. The radiation source modules may provide various drying methods for coated films using, for example, infrared radiation, and particularly the use of near-infrared radiation at, for example, a wavelength of 980 nm may enable effective evaporation of solvents and uniform drying of coatings. In the embodiment shown in FIG. 1, the radiation source modules are VCSEL modules 10a to 10d that use laser radiation in the near-infrared range to support the drying process of the battery electrode film 1 in a targeted and energy-efficient manner.

For drying the film on both sides, two first VCSEL modules 10a, 10b are arranged on the first side 101 of the battery electrode film 1. Only one radiation source module may be provided, or additional modules may also be provided. The radiation source modules are designed to emit first radiation 11a, 11b toward the first side 101 for drying. On the opposite side of the battery electrode film 1, optionally in an offset arrangement, two second VCSEL modules 10c, 10d may be arranged to emit second radiation 11c, 11d toward the second side 102 (in this case, the lower side) for additional drying. In the example shown in FIG. 1, as illustrated, the irradiation areas overlap in outer regions. On the second side, only one radiation source module may be provided, or additional modules may also be provided. The type and/or number of second radiation source modules may optionally differ from the type and/or number of first radiation source modules. As described above, the distances of one or more modules from the coated film may also differ from each other. Alternatively or additionally, the first and second radiation source modules may have at least partially different spectra.

FIG. 2 is a schematic plan view of a part of an exemplary drying line. Here, the film is dried only on one side by two drying modules X and Y and passes through the drying line along the transport direction 110. However, as shown, wrinkles 1a, peeling 1b, and/or cracks 1c may occur in the battery electrode film 1 after the process. This is because, in single-sided irradiation, heat must penetrate through the entire coating from one side, and higher temperatures are required at the irradiated surface. Furthermore, the temperature gradient is particularly steep because there is no heat input from the opposite side and heat is rapidly dissipated through the carrier film. This may result in non-uniform drying results, as schematically shown in FIG. 2.

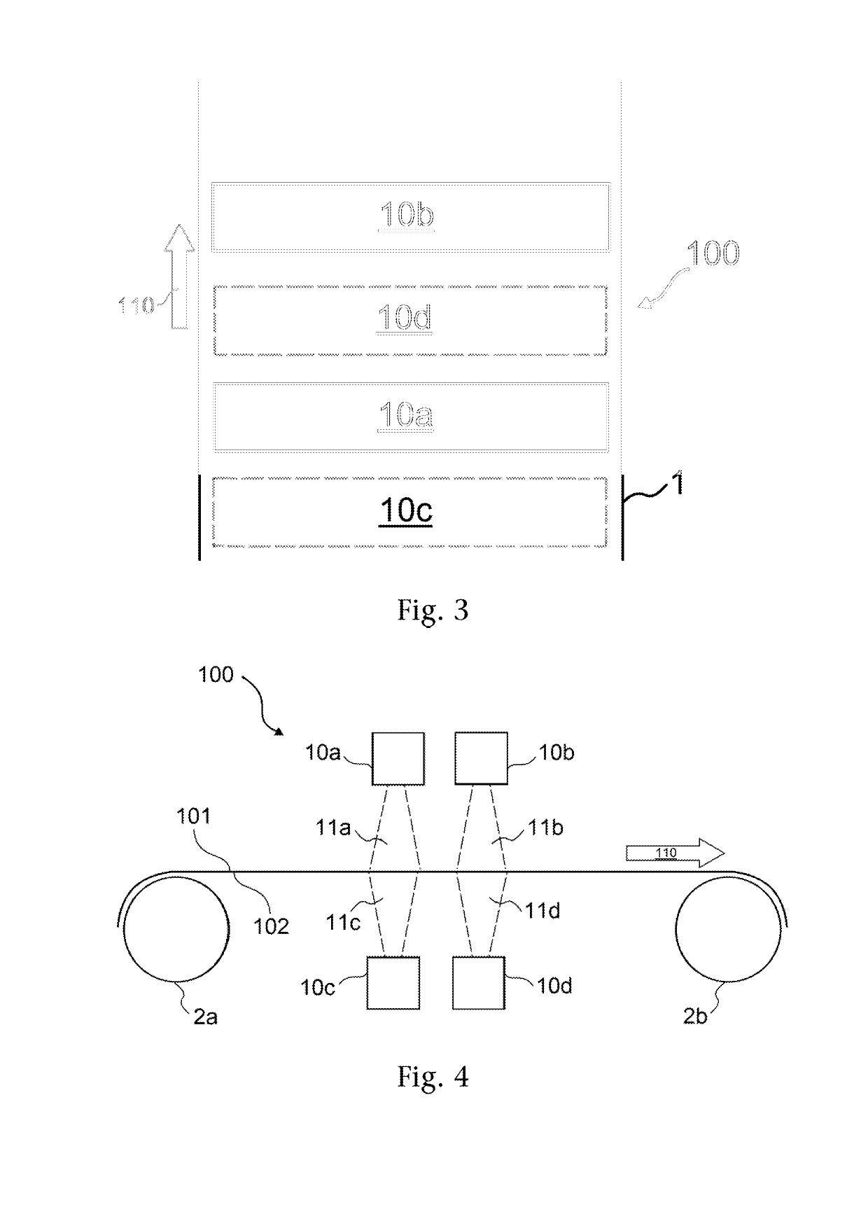

In contrast, FIG. 3 is a schematic plan view of a part of the system 100 of FIG. 1. In this case, the first radiation source modules 10a, 10b are arranged above the coated film 1 and are schematically shown as solid lines. The first radiation source modules are configured to emit first radiation toward the first side of the coated film. Not all radiation source modules are arranged on the same side of the coated film. The radiation source modules 10c, 10d are arranged below the coated film 1, i.e., on the opposite side 102, and are schematically shown as dashed lines. As shown in FIG. 3, after drying of the coated film on both sides by the VCSEL modules 10a, 10b on the upper side and the VCSEL modules 10c, 10d on the lower side, the battery electrode film 1 may have higher coating quality.

FIG. 4 is a schematic diagram of a second embodiment of the system 100 for drying coated films on both sides, where the radiation source modules 10a, 10c and 10b, 10d are arranged on a common axis and opposite each other. As shown, the VCSEL module 10c on the second side 102 of the battery electrode film 1 is arranged opposite to the VCSEL module 10a on the first side 101. The first radiation source module 10a and the second radiation source module 10c are arranged opposite each other and are designed to simultaneously irradiate the same area of the coated film from both sides 101, 102. Therefore, heat input may be made uniformly and simultaneously from both sides 101, 102. An additional radiation source module 10b may be arranged on the first side 101 and/or an additional radiation source module 10d may be arranged on the second side 102.

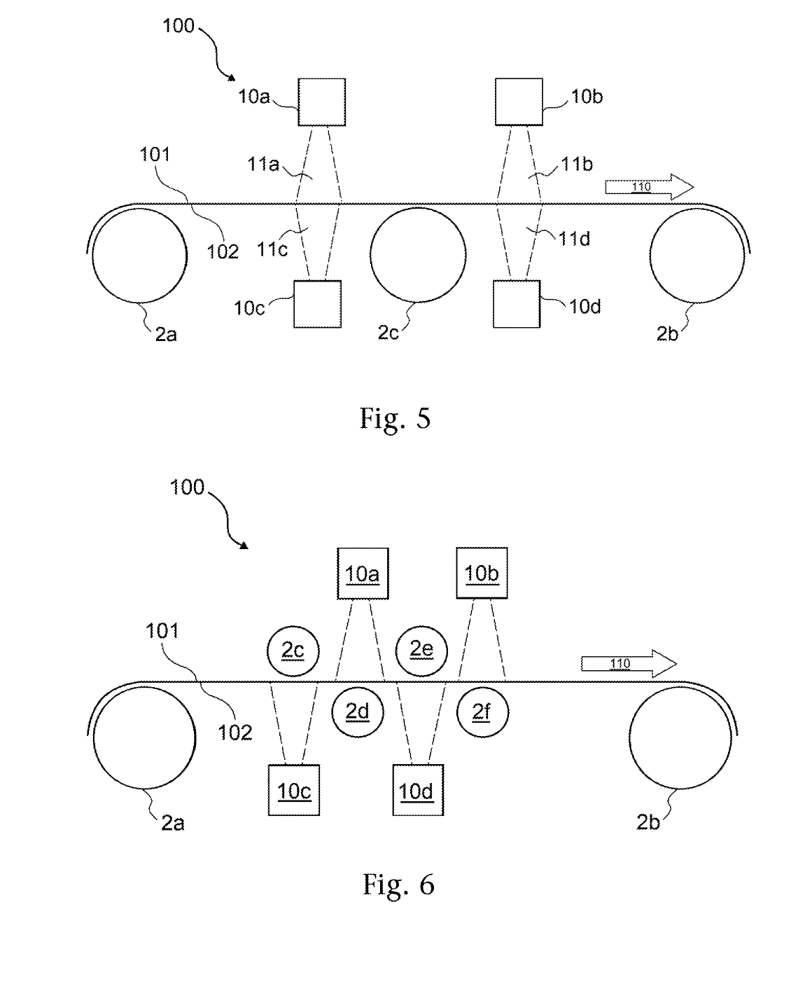

FIG. 5 is a schematic diagram of a third embodiment of the system 100 for drying coated films on both sides. The system further includes an additional second radiation source module 10d in addition to the second radiation source module 10c. The additional second radiation source module 10d is configured to emit second radiation 11d toward the second side 102 of the coated film. A transport means 2c is arranged between the two second radiation source modules 10c, 10d, i.e., between the second radiation source module 10c and the additional second radiation source module. The transport means 2c is an additional transport means, for example, a third transport means, and is arranged between the opposing VCSEL module pairs 10a, 10c and 10b, 10d. This may ensure that the battery electrode film 1 is reliably guided through the system 100. The film may be transported particularly centrally along the transport direction 110 from the upstream VCSEL modules 10a, 10c to the downstream VCSEL modules 10b, 10d. The transport means 2c arranged between the radiation source modules 10c, 10d may at least partially reduce unwanted scattered radiation.

FIG. 6 is a schematic diagram of a fourth embodiment of the system 100 for drying coated films on both sides. In this embodiment, respective transport means 2c to 2f are arranged opposite corresponding VCSEL modules 10a to 10d in a one-to-one manner. With this arrangement, the battery electrode film 1 may be reliably guided through the system 100 along the transport direction 110, while being irradiated from the first side and the second side by the VCSEL modules 10a to 10d. Due to the offset arrangement of the radiation source modules, overheating at positions irradiated from both sides may be prevented. Scattered radiation may also be reduced. The first radiation source modules 10a or 10b and the second radiation source modules 10c or 10d may be arranged offset from each other and configured to simultaneously irradiate different areas of the coated film from the first side 101 and the second side 102, respectively.

As shown in FIG. 6, a plurality of first radiation source modules 10a, 10b and a plurality of second radiation source modules 10c, 10d may be provided. The plurality of transport means 2a to 2f and the plurality of first radiation source modules 10a, 10b and/or second radiation source modules 10c, 10d may be arranged alternately on at least one side of the coated film, such that at least one radiation source module 10a to 10d on the first side or the second side is arranged between two transport means 2a to 2f. The plurality of radiation source modules 10a to 10d may be arranged alternately and configured to alternately irradiate the coated film from the first side 101 and the second side 102.

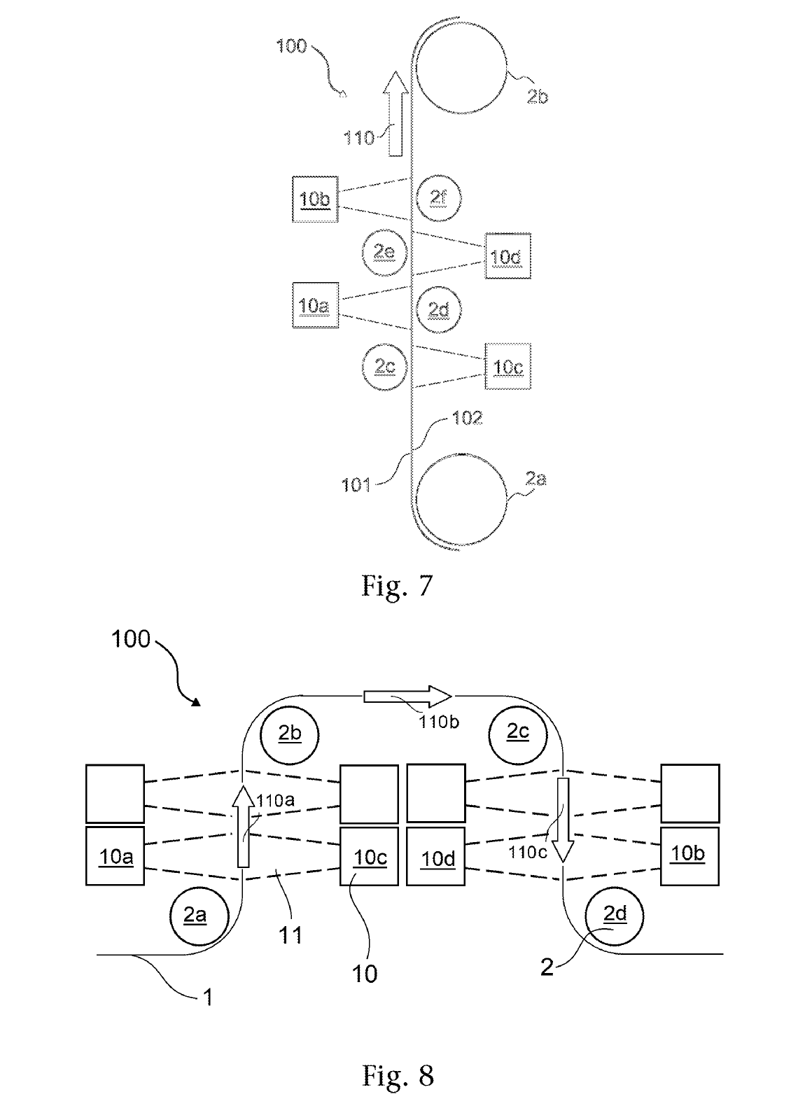

FIG. 7 is a schematic diagram of a fifth embodiment of the system 100 for drying coated films on both sides, in which the transport direction 110 is vertically aligned, unlike the other embodiments. Even with a vertical transport direction, various arrangements or sequences of one or more first radiation source modules, one or more second radiation source modules, and one or more transport means may be provided, for example as described above. Drying is performed in the same manner as in the other embodiments, but moisture, such as evaporating solvent from the battery electrode film, may more easily escape upward. In the illustrated embodiment, the arrangement of the VCSEL modules 10a to 10d and the transport means 2c to 2f corresponds to the fourth embodiment. However, other embodiments or variations thereof may also be vertically aligned. In the illustrated arrangement, the first radiation source modules 10a, 10b are configured to irradiate the coated film from the first side 101 in a horizontal direction. The second radiation source modules 10c, 10d are configured to irradiate the coated film from the second side 102 in an opposite horizontal direction. The transport means 2a to 2f are configured to pass the coated film between the first radiation source modules 10a, 10b and the second radiation source modules 10c, 10d in a vertical direction.

FIG. 8 is a schematic diagram of a sixth embodiment of the system 100 for drying coated films on both sides. The entire system may be formed in a folded arrangement. As schematically shown in FIG. 8, the system may be configured to guide the coated film along a folded path past a plurality of radiation source modules by a plurality of transport means 2a to 2d. In this embodiment, the battery electrode film 1 proceeds along a curved or S-shaped path. The transport means 2 and/or 2a to 2d may be arranged to guide the film through a sequence of radiation source modules 10 and/or 10a to 10d arranged on both sides of the battery electrode film 1 along alternately aligned transport directions 110a to 110c. During transport, the battery electrode film 1 is deflected by the transport means, so that the alignment of the transport directions 110a to 110c alternately changes. In this embodiment as well, the arrangement of the VCSEL modules 10 and the transport means 2 may be a cumulative arrangement (modules of the same type arranged opposite each other), an alternating arrangement, or a combination thereof. In particular, the system may be configured to, using the plurality of transport means, pass the coated film upward in a vertical direction 110a between a first radiation source module 10a and a second radiation source module 10c in a first vertical section, and to pass the coated film downward in a vertical direction 110c between an additional first radiation source module 10b and an additional second radiation source module 10d in a second vertical section.

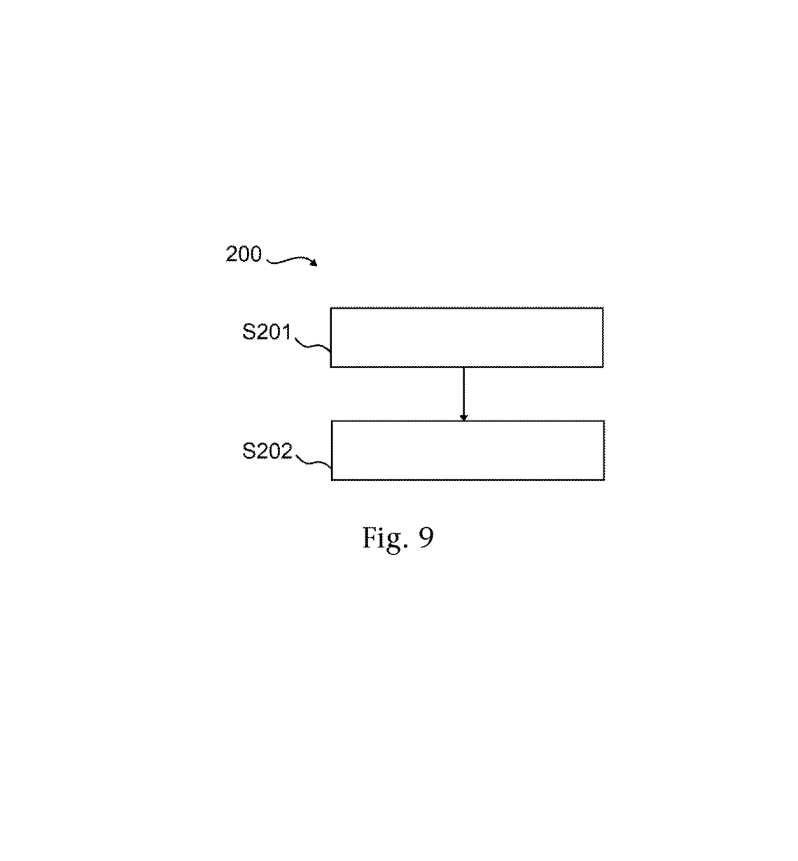

FIG. 9 is a flowchart of a method 200 for drying a coated film on both sides, particularly a battery electrode film 1. In S201, first radiation 11a, 11b is emitted toward a first side 101 of the battery electrode film 1. In S202, second radiation 11c, 11d is emitted toward a second side 102 of the battery electrode film 1. S201 and S202 may be performed sequentially or simultaneously. The radiation 11a to 11d may preferably be emitted by VCSEL modules 10a to 10d designed for this purpose. In this case, a system for drying a coated film on both sides as described above may be used.

Each element may be configured as described in more detail above. Features of one or more embodiments may be combined. Similar elements are indicated by the same reference numerals. To avoid repetition, differences or additions are emphasized in further embodiments. The drying apparatus according to the present disclosure may include, for a system for drying a coated film on both sides as described within the scope of the present disclosure, one or more first radiation source modules configured to emit first radiation toward a first side of the coated film and one or more second radiation source modules configured to emit second radiation toward a second side of the coated film.

In summary, aspects of the approach proposed herein may provide an improved system and apparatus for drying a coated film. In particular, the proposed approach may significantly reduce temperature gradients to enable more uniform drying results across an entire layer thickness. This may reduce the risk of damage such as overheating, cracking, delamination or separation of layers, and also reduce deformation such as wrinkle formation. Furthermore, this may enable shorter drying lines and thus more efficient drying processes.

What is claimed is:

1. A system for drying a coated film on both sides, the system comprising:
a first radiation source module configured to emit first radiation toward a first side of the coated film;
a second radiation source module configured to emit second radiation toward a second side of the coated film; and
a transport means configured to guide the coated film along a transport direction between the first and second radiation source modules.

2. The system of claim 1, wherein at least one of the radiation source modules is a laser diode module, the laser diode module being a VCSEL module comprising a plurality of VCSELs.

3. The system of claim 1, wherein the first radiation source module and the second radiation source module are arranged opposite each other and are configured to simultaneously irradiate the same area of the coated film from both sides.

4. The system of claim 1, wherein the first radiation source module and the second radiation source module are arranged offset from each other and are configured to simultaneously irradiate different areas of the coated film from both sides.

5. The system of claim 1, wherein at least one transport means is arranged opposite the first radiation source module or the second radiation source module.

6. The system of claim 1, wherein the system further comprises an additional second radiation source module in addition to the second radiation source module,
wherein the additional second radiation source module is configured to emit additional second radiation toward the second side of the coated film, and
wherein the transport means is arranged between the second radiation source module and the additional second radiation source module.

7. The system of claim 1, wherein the system comprises a plurality of transport means, a plurality of first radiation source modules, and a plurality of second radiation source modules.

8. The system of claim 7, wherein the plurality of transport means and the plurality of first radiation source modules or the plurality of second radiation source modules are alternately arranged, such that at least one radiation source module on the first side or the second side is arranged between two transport means.

9. The system of claim 1, wherein a plurality of radiation source modules are alternately arranged and configured to alternately irradiate the coated film from the first side and the second side.

10. The system of claim 1, wherein
the first radiation source module is configured to irradiate the coated film from the first side in a horizontal direction,
the second radiation source module is configured to irradiate the coated film from the second side in an opposite horizontal direction, and
the transport means is configured to pass the coated film between the first radiation source module and the second radiation source module in a vertical direction.

11. The system of claim 1, wherein the system is configured to guide the coated film, by a plurality of transport means, along a folded path past a plurality of radiation source modules.

12. The system of claim 11, wherein the system is configured to, using a plurality of transport means:
pass the coated film upward in a vertical direction between the first radiation source module and the second radiation source module in a first vertical section; and
pass the coated film downward in a vertical direction between an additional first radiation source module and an additional second radiation source module in a second vertical section.

13. The system of claim 1, wherein the transport means comprises rollers or air cushions.

14. The system of claim 1, wherein
the first radiation source module is configured to emit radiation having a first radiation spectrum, and
the second radiation source module is configured to emit radiation having a second radiation spectrum different from the first radiation spectrum.

15. The system of claim 14, wherein, for a single-sided coated film, the system is configured to:
irradiate a coated side of the film with radiation in a near-infrared range of 780–1100 nm; and
irradiate a non-coated side of the film with radiation in a visible light range of 440–550 nm.

16. The system of claim 1, wherein the system further comprises a convection dryer using hot air, the convection dryer being arranged downstream of the radiation source modules in the transport direction.

17. A drying apparatus for the system of claim 1, the drying apparatus comprising:
a first radiation source module configured to emit first radiation toward a first side of the coated film; and
a second radiation source module configured to emit second radiation toward a second side of the coated film.

18. A method for drying a coated film on both sides, the method comprising:
emitting radiation toward a first side of the coated film; and
emitting radiation toward a second side of the coated film.
